(19) United States
(12) Patent Application Publication
(10) Pub. No.: US 2014/0297280 A1
(43) Pub. Date: Oct. 2, 2014

(54) SPEAKER IDENTIFICATION

(71) Applicant: NEXIDIA INC., Atlanta, GA (US)

(72) Inventors: Neeraj Singh Verma, Lawrenceville, GA (US); Robert William Morris, Decatur, GA (US)

(73) Assignee: Nexidia Inc., Atlanta, GA (US)

(21) Appl. No.: 13/855,247

(22) Filed: Apr. 2, 2013

(51) Int. Cl. G10L 17/02

(52) U.S. Cl. CPC G10L 17/02
USPC 704/246

(57) ABSTRACT

In an aspect, in general, a system includes a first input for receiving a first data representing an interaction among a plurality of parties, the first data identifying a plurality of parts of the interaction and identifying a plurality of segments associated with each part of the plurality of parts, a second input for receiving a second data associating each of one or more labels with one or more corresponding query phrases, a searching module for searching the first data to identify putative instances of the query phrases, and a classifier for labeling the parts of the interaction associated with the identified putative instances of the query phrases with the labels corresponding to the identified query phrases.

### BACKGROUND

This invention relates to speaker identification.

Speaker “diarization” of an audio recording of a conversation is a process for partitioning the recording according to a number of speakers participating in the conversation. For example, an audio recording of a conversation between two speakers can be partitioned into a number of portions with some of the portions corresponding to a first speaker of the two speakers speaking and other of the portions corresponding to a second speaker of the two speakers speaking.

Various post-processing of the diarized audio recording can be performed.

### SUMMARY

In an aspect, in general, a system includes a first input for receiving a first data representing an interaction among a plurality of parties, the first data identifying a plurality of parts of the interaction and identifying a plurality of segments associated with each part of the plurality of parts, a second input for receiving a second data associating each of one or more labels with one or more corresponding query phrases, a searching module for searching the first data to identify putative instances of the query phrases, and a classifier for labeling the parts of the interaction associated with the identified putative instances of the query phrases with the labels corresponding to the identified query phrases.

Aspects may include one or more of the following features.

The first data may represent an audio signal including the interaction among the plurality of speakers. The first data may represent a text based chat log including the interaction among the plurality of speakers. The system may include a recording module for forming the first data representing the audio signal including recording an audio signal of the interaction between the plurality of parties, segmenting the audio signal into the plurality of segments, and associating each of the segments with a part of the plurality of parts, wherein each part of the plurality of parts corresponds to one of the parties of the plurality of parties. The recording module may be configured to segment the audio signal according to the different acoustic characteristics of the plurality of parties.

The system may include a recording module for forming the first data representing the text based chat log including logging a textual interaction between the plurality of parties, segmenting the textual interaction into the plurality of segments, and associating each of the segments with a part of the plurality of parts, wherein each part of the plurality of parts corresponds to one of the parties of the plurality of parties.

The searching module may be configured to, for each label of at least some of the one or more labels, search for putative instances of at least some of the one or more query phrases corresponding to the label in at least some of the plurality of segments which are associated with at least some of the plurality of parts. The searching module may include a speech processor and each putative instance is associated with a hit quality that characterizes a quality of recognition of a corresponding query phrase of the one or more query phrases. The searching module may include a wordspotting system. The searching module may include a text processor. At least some of the query phrases may be known to be present in the first data. The first data may be diarized according to the interaction.

In another aspect, in general, a computer implemented method includes receiving a first data representing an interaction among a plurality of parties, the first data identifying a plurality of parts of the interaction and identifying a plurality of segments associated with each part of the plurality of parts, receiving a second data associating each of one or more labels with one or more corresponding query phrases, searching the first data to identify putative instances of the query phrases, and labeling the parts of the interaction associated with the identified putative instances of the query phrases with the labels corresponding to the identified query phrases.

Aspects may include one or more of the following features.

The first data may represent an audio signal comprising the interaction among the plurality of speakers. The first data may represent a text based chat log comprising the interaction among the plurality of speakers. The method may include forming the first data representing the audio signal including recording an audio signal of the interaction between the plurality of parties, segmenting the audio signal into the plurality of segments, and associating each of the segments with a part of the plurality of parts, wherein each part of the plurality of parts corresponds to one of the parties of the plurality of parties. Segmenting the audio signal into the plurality of segments may include segmenting the audio signal according to the different acoustic characteristics of the plurality of parties.

The method may include forming the first data representing the text based chat log including logging a textual interaction between the plurality of parties, segmenting the textual interaction into the plurality of segments, and associating each of the segments with a part of the plurality of parts, wherein each part of the plurality of parts corresponds to one of the parties of the plurality of parties. Searching the first data may include, for each label of at least some of the one or more labels, searching for putative instances of at least some of the one or more query phrases corresponding to the label in at least some of the plurality of segments which are associated with at least some of the plurality of parts.

Searching the first data may include associating each putative instance with a hit quality that characterizes a quality of recognition of a corresponding query phrase of the one or more query phrases. At least some of the query phrases may be known to be present in the first data. The first data may be diarized according to the interaction.

In another aspect in general, software stored on a computer-readable medium comprising instructions for causing a data processing system to receive a first data representing an interaction among a plurality of parties, the first data identifying a plurality of parts of the interaction and identifying a plurality of segments associated with each part of the plurality of parts, receive a second data associating each of one or more labels with one or more corresponding query phrases, search the first data to identify putative instances of the query phrases, and label the parts of the interaction associated with the identified putative instances of the query phrases with the labels corresponding to the identified query phrases.

Embodiments may have one or more of the following advantages.

Among other advantages the speaker identification system can improve the speed and accuracy of searching an audio recording.

Other features and advantages of the invention are apparent from the following description, and from the claims.

### DESCRIPTION OF DRAWINGS

FIG. 1 illustrates a customer service telephone conversation.

FIG. 2 is a diarized audio recording.

FIG. 3 is a query based speaker identification system.

FIG. 4 is a diarized audio recording with the speakers identified.

FIG. 5 is an audio recording search system which operates on diarized audio recordings with speakers identified.

FIG. 6 illustrates an example of the system of FIG. 3 in use.

FIG. 7 illustrates an example of the system of FIG. 5 in use.

### DESCRIPTION

### 1 Overview

In general, the systems described herein process transcriptions of interactions between users of one or more communication systems. For example, the transcriptions can be derived from audio recordings of telephone conversations between users or from text logs of chat sessions between users. The following description relates to one such system which processes call records from a customer service call center. However, the reader will recognize that the system and the techniques applied therein can also be applied to other types of transcriptions of interactions between users such as logs of chat sessions between users.

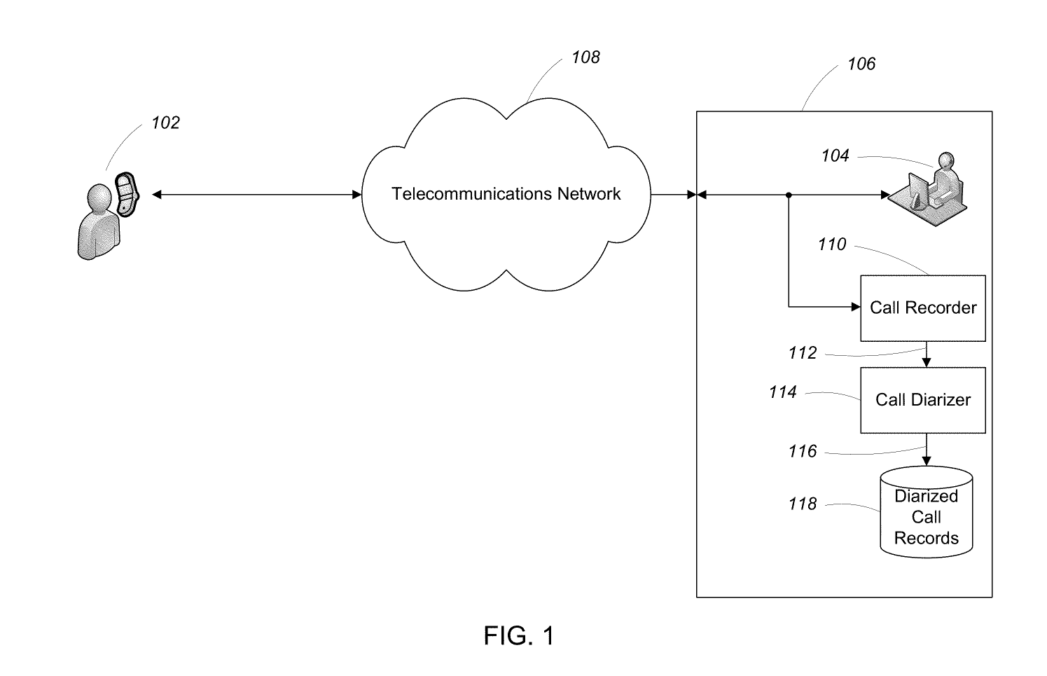

Referring to FIG. 1, a telephone conversation between a customer 102 and a customer service agent 104 at a customer service call center 106 takes place over a telecommunications network 108. The customer service call center 106 includes a call recorder 110 which records the conversation. The recorded conversation 112 is provided to a call diarizer 114 which generates a diarized call record 116. The diarized call record 116 is stored in a database 118 for later use.

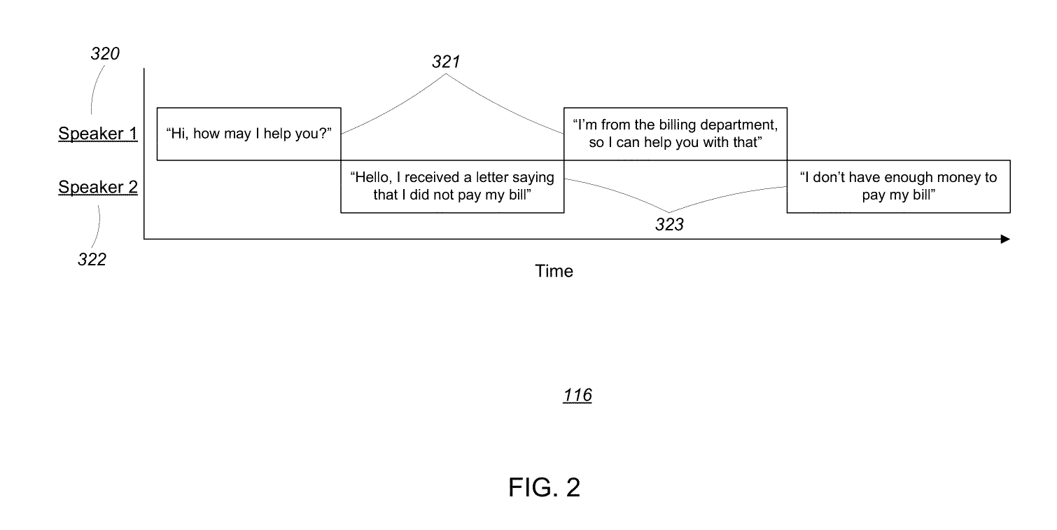

Referring to FIG. 2, one example of a diarized call record 116 includes a number of portions 321 of the recorded conversation 112 which are associated with a first speaker 320 (i.e., Speaker 1) and number of other portions 323 of the recorded conversation 112 which are associated with a second speaker 322 (i.e., Speaker 2). In other examples, a recorded conversation between more than two speakers can be diarized in the same way as the diarized recorded conversation 116.

One use of a diarized call record 116 such as that shown in FIG. 2 is to search the audio portions 321, 323 associated with one of the speakers 320, 322 to determine the presence and/or temporal location(s) of one or more phrases (i.e., one or more words). Since only a subset of the portions 321, 323 of the diarized call record 116 are searched, the efficiency and accuracy of the search operation may be improved (i.e., due to a reduction in the total search space). For example, a search for a given phrase can be performed on only the portions of audio 321 which correspond to the first speaker 320, thereby restricting the search space and making the search operation more efficient and accurate and efficient.

However, one problem associated with a diarized conversation 116 such as that shown in FIG. 2 is that a user wishing to search for a phrase generally does not have any information as to the identity of the speakers 320, 322. For example, a user might want to search for a phrase spoken by the customer service agent 104 in the conversation of FIG. 1. However, the user does not have prior knowledge as to which of the speakers 320, 322 identified in the diarized call record 116 is the customer service agent 104. In some cases, the user can manually identify the speakers by listening to one or more portions of the diarized call record 116, and based on what they hear, identifying the speaker in those portions as either the customer 102 or the customer service agent 104. In some examples, other portions that match the acoustic characteristics of the identified speaker are subsequently automatically assigned by the system. The user can then search for the phrase in the portions of the diarized call record 116 identified as being associated with the customer service agent 104. Even in the simplest cases, such a manual identification process is time consuming and tedious. In more complicated cases where more than two speakers are participating in a conversation, such a manual identification process becomes even more complex. Thus, there is a need for a way to automate the process of speaker identification and to use the result of the speaker identification to efficiently search a diarized call record 116.

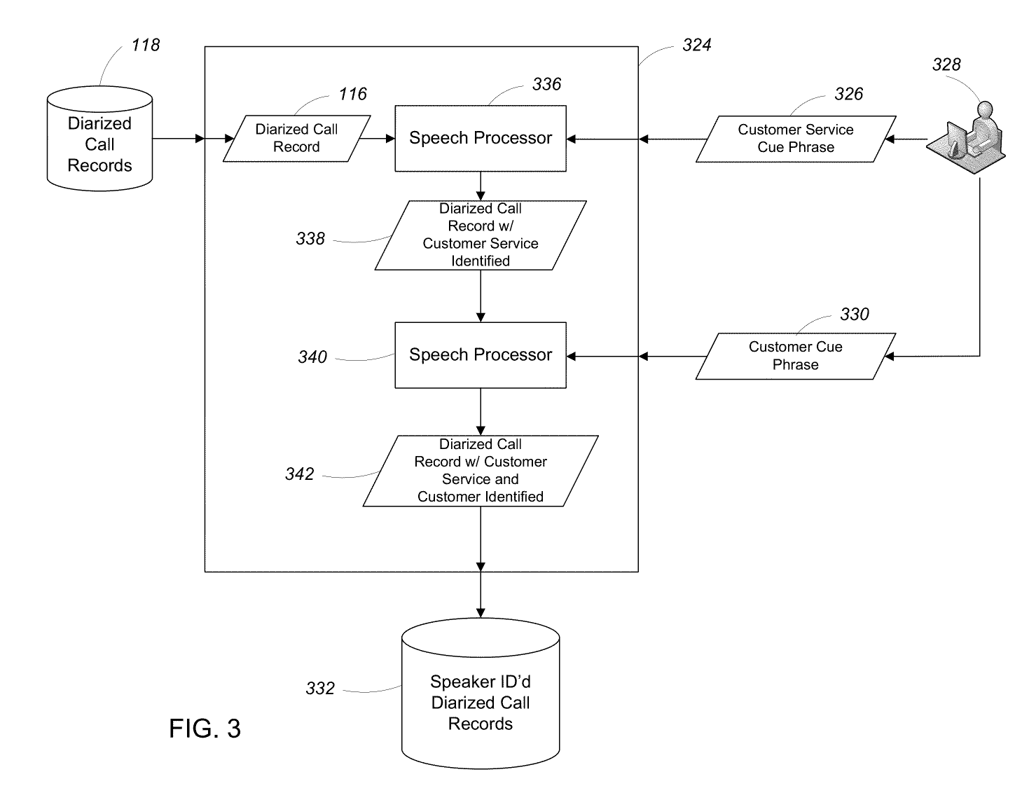

Referring to FIG. 3, a query based speaker identification system 324 is configured to utilize contextual information provided by a user 328 as queries to identify speakers in diarized call records. The query based speaker identification system 324 receives the database of diarized call records 118, a customer service cue phrase 326 from the user 328, and a customer cue phrase 330 from the user.

In some examples, the user 328 supplies the cue phrases for the different speaker types (e.g. customer service agent, customer) by using a command such as:

SPEAKER_IDEN(speakerType,phrase(s))

The system 324 processes one or more diarized call records 116 of the database of diarized call records 118 using the cue phrases 326, 328 to generate one or more diarized call records with one or more of the speakers in the call records identified, referred to as speaker ID'd call records 342. The speaker ID'd call records 322 are stored in a database of speaker ID'd call records 332.

Within the query based speaker identification system 324, a diarized call record 116 from the database of diarized call records 118 and the customer service cue phrase 326 are passed to a first speech processor 336 (e.g., a wordspotting system). The first speech processor 336 searches all of the portions of the diarized call record 116 to identify portions which include putative instances of the customer service cue phrase 326. Each identified putative instance includes a hit quality score which characterizes how confident the first speech processor 336 is that the identified putative instance of the customer service cue phrase matches the actual customer service cue phrase 326.

In general, the customer service cue phrase 326 is a phrase that is known to be commonly spoken by customer service agents 104 and to be rarely spoken by customers 102. Thus, it is likely that the portions of the diarized call record 116 which correspond to the customer service agent 104 speaking will include the majority, if not all of the putative instances of the customer service cue phrase 326 identified by the first speech processor 336. The speaker associated with the portions of the diarized call record 116 which include the majority of the putative instances of the customer service cue phrase 326 is identified as the customer service agent 104. The result of the first speech processor 326 is a first speaker ID'd diarized call record 338 in which the customer service agent 104 is identified.

The first speaker ID'd diarized call record 338 is provided, along with the customer cue phrase 330 to a second speech processor 340 (e.g., a wordspotting system). The second speech processor 340 searches all of the portions of the first speaker ID'd diarized call record 338 to identify portions which include putative instances of the customer cue phrase 330. As was the case above, each identified putative instance includes a hit quality score which characterizes how confident the second speech processor 340 is that the identified putative instance of the customer cue phrase matches the actual customer service cue phrase 330.

In general, the customer cue phrase 330 is a phrase that is known to be commonly spoken by customers 102 and to be rarely spoken by customer service agents 104. Thus, it is likely that the portions of the first speaker ID'd diarized call record 338 which correspond to the customer 102 speaking will include the majority, if not all of the putative instances of the customer cue phrase 330 identified by the second speech processor 340. The speaker associated with the portions of the first speaker ID'd diarized call record 338 which include the majority of the putative instances of the customer cue phrase 330 is identified as the customer 102. The result of the second speech processor 326 is a second speaker ID'd diarized call record 342 in which the customer service agent 104 and the customer 102 are identified. The second speaker ID'd call record 342 is stored in the database of speaker ID'd call records 332 for later use.

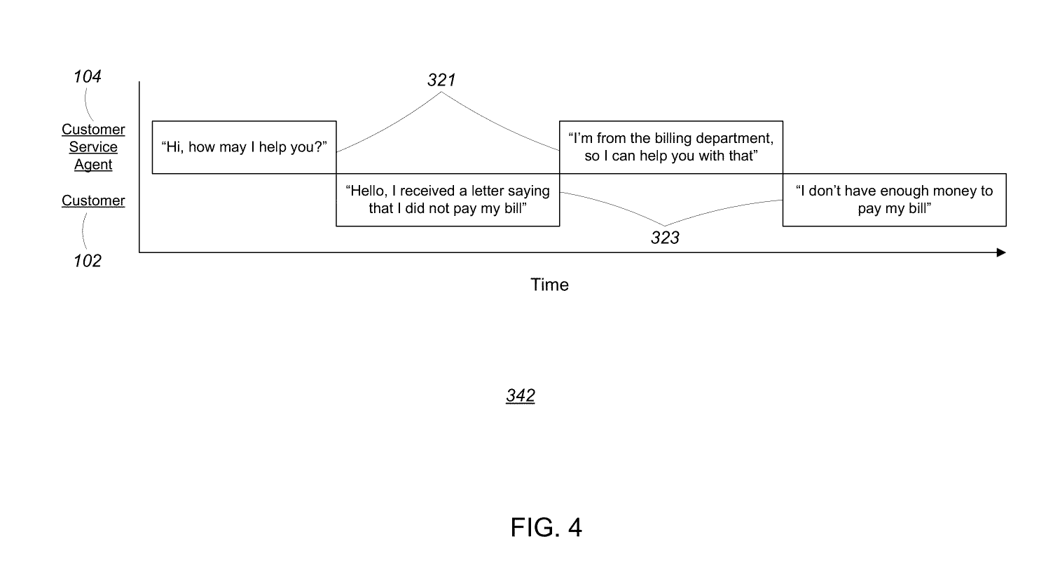

Referring to FIG. 4, one example of the second speaker ID'd diarized call record 342 is substantially similar to the diarized call record 116 of FIG. 2. However, the second speaker ID'd diarized call record 342 includes a number of portions 321 which are identified as being associated with the customer service agent 104 and another number of portions 323 which are identified as being associated with the customer 102.

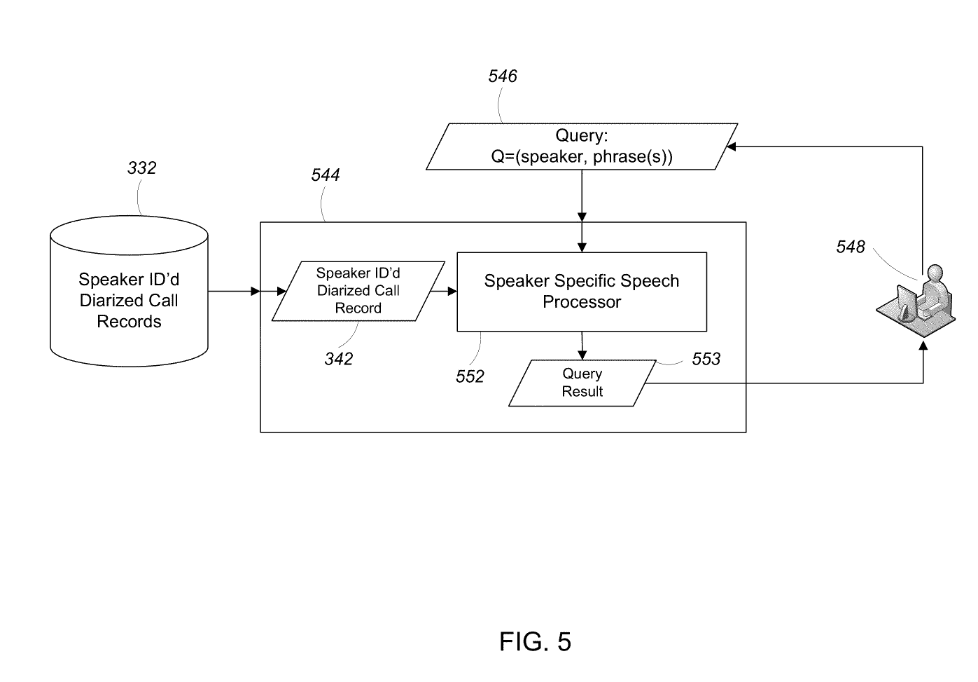

Referring to FIG. 5, a speaker specific searching system 544 receives a query 546 from a user 548 and the database of speaker ID'd call records 332 as inputs. The speaker specific searching system 544 searches for a user-specified phrase in portions of a diarized call record which correspond to a user-specified speaker and returns a search result to the user 548.

In some examples, the query 546 specified by the user takes the following form:

Q=(speakerType, phrase(s));

For example, the user 548 may specify a query such as:

Q=(Customer, “I received a letter”);

Within the speaker specific searching system 544, the query 546 and a speaker ID'd diarized call record 550 are provided to a speaker specific speech processor 552 which processes the portions of the speaker ID'd diarized call record 550 which are associated with the speakerType specified in the query to identify putative instances of the phrase(s) included in the query. Each identified putative instance includes a hit quality score which characterizes how confident the speaker specific speech processor 552 is that the identified putative instance of the phrase(s) matches the actual phrase(s) specified by the user. In this way, the efficiency and accuracy of searching the audio recording 112 is made more efficient since the searching operation is limited to only those portions of the audio recording 112 which are related to a specific speaker, thereby restricting the search space.

The query result 553 of the speaker specific speech processor 552 is provided to the user 548. In some examples, each of the putative instances, including the quality and temporal location of each putative instance, is shown to the user 548 on a computer screen. In some examples, the user 548 can interact with the computer screen to verify that a putative instance is correct, for example, by listening to the audio recording at and around the temporal location of the putative instance.

### 2 Examples

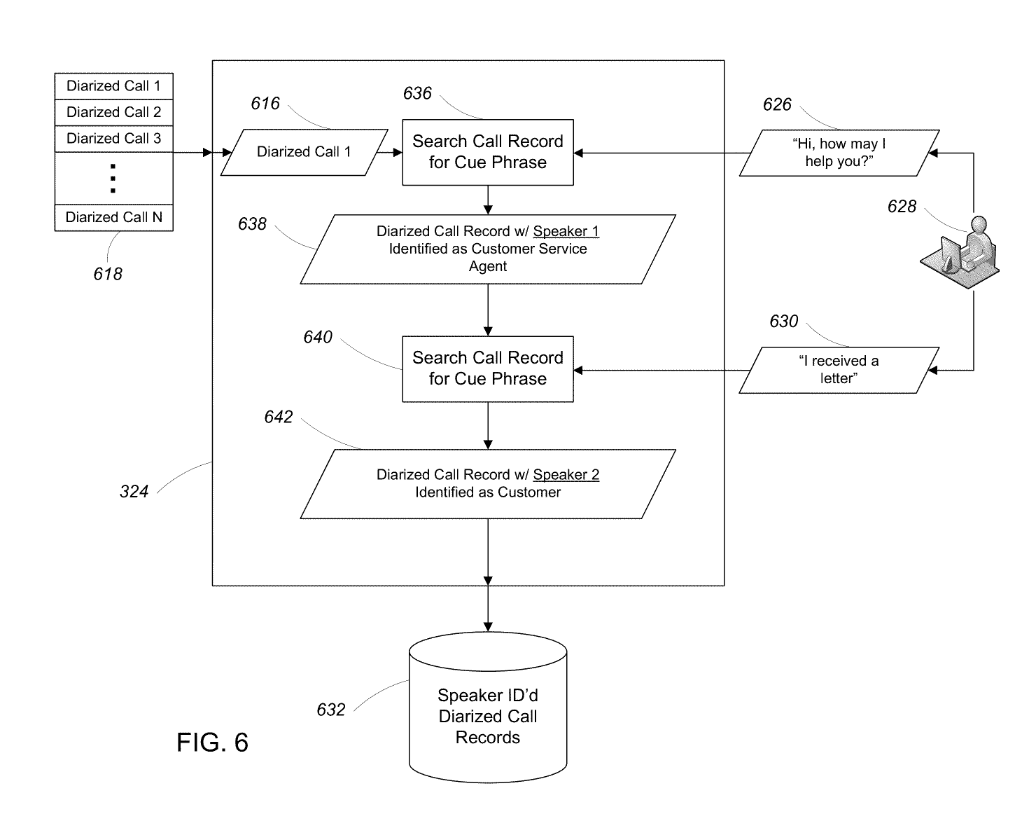

Referring to FIG. 6, one example of the operation of the query based speaker identification system 324 of FIG. 3 is illustrated. The system 324 receives N diarized call records 618, a customer service cue phrase 626 from a user 628, and a customer cue phrase 630 from the user 628. The customer service cue phrase 626 includes the phrase “Hi, how may I help you?” which is known to be a phrase which is commonly spoken by customer service agents 104. The customer cue phrase 630 includes the phrase “I received a letter” which is known to be a phrase which is commonly spoken by customers 102.

In some examples, the user 628 supplies the cue phrases for the different speaker types (e.g, customer service agent, customer) by using a command such as:

SPEAKER_IDEN(Customer Service, “Hi, how may I help you”)

or

SPEAKER_IDEN(Customer,“I received a letter”)

In the present example, a diarized call record 616, which is the same as the diarized call record 116 illustrated in FIG. 2, is selected from the N diarized call records 618. The diarized call record 616 is passed to a first speech processor 636 along with the customer service cue phrase 626 (i.e., “Hi, how may I help you?”). The first speech processor 636 searches the diarized call record 616 for the customer service cue phrase 626 and locates a putative instance of the customer service cue phrase 626 in the first portion of the diarized call record 616 which happens to be associated with the first speaker 320. Thus, the result of the first speech processor 636 is a first speaker ID'd diarized call record 638 in which the first speaker 320 is identified as the customer service agent 104.

The result 638 of the first speech processor 636 is passed to a second speech processor 640 along with the customer cue phrase 630 (i.e., “I received a letter”). The second speech processor 640 searches the result 638 of the first speech processor 636 for the customer cue phrase 626 and locates a putative instance of the customer cue phrase in the second portion of the result 638. Since the second portion of the result 638 is associated with the second speaker 322, the second speech processor 640 identifies the second speaker 322 as the customer. The result of the second speech processor 640 is a second speaker ID'd diarized call record 642 in which the first speaker 320 is identified as the customer service agent and the second speaker 322 is identified as the customer. The second speaker ID'd call record 642 is stored in a database of speaker ID'd call records 632 for later use.

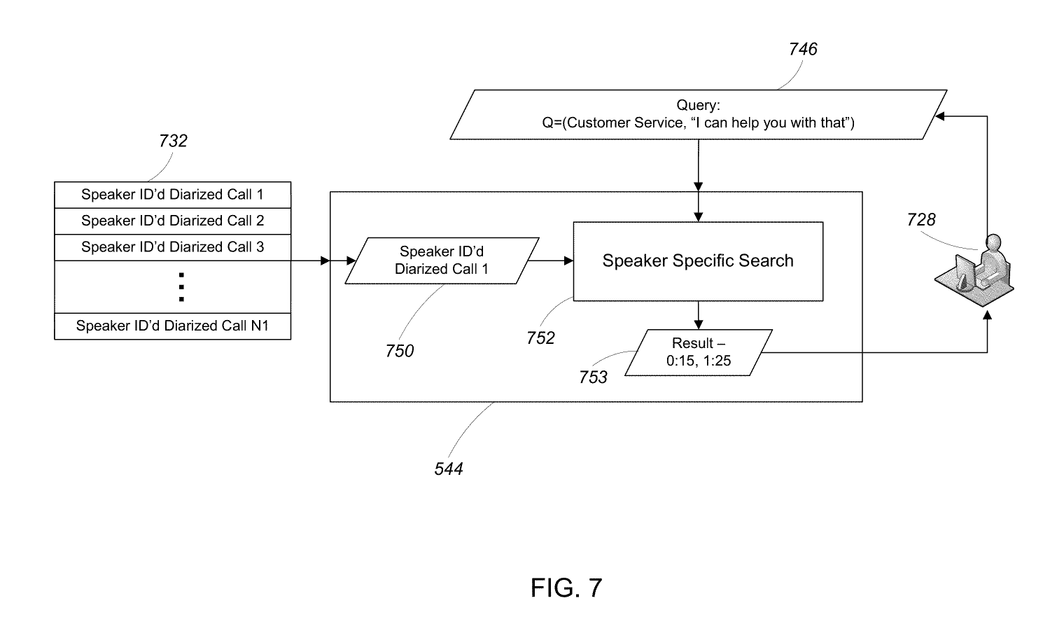

Referring to FIG. 7, one example of the operation of speaker specific searching system 544 of FIG. 5 is illustrated. The speaker specific searching system 544 receives N speaker ID'd diarized call records 732 and a query 746 as inputs. In the present example, the query 746 is:

Q=(Customer Service, “I can help you with that”)

Such a query indicates that portions of a diarized call record which are associated with a customer service agent should be searched for putative instances of the term “I can help you with that.”

In the present example, a speaker ID'd diarized call record 750, which is the same as the second speaker ID'd diarized call record 342 of FIG. 4, is selected from the N speaker ID'd diarized call records 732. The speaker ID'd diarized call record 750 is passed to a speaker specific speech processor 752 along with the query 746. The speaker specific speech processor 752 processes the portions of the speaker ID'd diarized call record 750 which are associated with Customer Service as is specified in the query 746 to identify putative instances of the phrase “I can help you with that.” The result 753 of the search (e.g., one or more timestamps indicating the temporal locations of the putative instances of the phrase) is passed out of the system 544 and presented to the user 728.

### 3 Alternatives

In some examples, a conversation involving more than two speakers is included in a diarized call record. In other examples, a diarized call record of a conversation between a number of speakers includes more diarized groups than there are speakers.

While the examples described above identify all speakers in a diarized call record, in some examples, it is sufficient to identify less than all of the speakers (i.e., a speaker of interest) in the diarized call record.

The examples described above generally label speaker segregated (i.e., diarized) data by the roles of the speakers as indicated by the presence of user specified queries. However, the speaker segregated data can be labeled according to a number of different criteria. For example, the speaker segregated data may be labeled according two or more topics discussed by the speakers in the speaker segregated data.

In some examples, the individual tracks (i.e., the single speaker records) of the diarized call records are identified by an automated segmentation process which identifies two or more speakers on the call based on the voice characteristics of the two or more speakers.

In some examples, the speaker identification system can be used to segregate data into portions that do or do not include sensitive information such as credit card numbers.

While the above description relates to speaker identification in diarized call records recorded at customer service call centers, it is noted that the same techniques can be used to identify the parties in a log of a text interaction (e.g., a chat session) where the parties in the interaction are not labeled. In such a case, rather than using speech processors, a structured query language using text parsing and searching algorithms are used.

In some examples, a text interaction between two or more parties includes macros (e.g., automatically generated text) that are used by agents in chat rooms for basic or common interactions. In such examples, a macro may be a valid speaker type.

4 Implementations

Systems that implement the techniques described above can be implemented in software, in firmware, in digital electronic circuitry, or in computer hardware, or in combinations of them. The system can include a computer program product tangibly embodied in a machine-readable storage device for execution by a programmable processor, and method steps can be performed by a programmable processor executing a program of instructions to perform functions by operating on input data and generating output. The system can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

It is to be understood that the foregoing description is intended to illustrate and not to limit the scope of the invention, which is defined by the scope of the appended claims. Other embodiments are within the scope of the following claims.

What is claimed is:

1. A system comprising:
a first input for receiving a first data representing an interaction among a plurality of parties, the first data identifying a plurality of parts of the interaction and identifying a plurality of segments associated with each part of the plurality of parts;
a second input for receiving a second data associating each of one or more labels with one or more corresponding query phrases;
a searching module for searching the first data to identify putative instances of the query phrases; and
a classifier for labeling the parts of the interaction associated with the identified putative instances of the query phrases with the labels corresponding to the identified query phrases.

2. The system of claim 1 wherein the first data represents an audio signal comprising the interaction among the plurality of speakers.

3. The system of claim 1 wherein the first data represents a text based chat log comprising the interaction among the plurality of speakers.

4. The system of claim 2 further comprising a recording module for forming the first data representing the audio signal including recording an audio signal of the interaction between the plurality of parties, segmenting the audio signal into the plurality of segments, and associating each of the segments with a part of the plurality of parts, wherein each part of the plurality of parts corresponds to one of the parties of the plurality of parties.

5. The system of claim 3 further comprising a recording module for forming the first data representing the text based chat log including logging a textual interaction between the plurality of parties, segmenting the textual interaction into the plurality of segments, and associating each of the segments with a part of the plurality of parts, wherein each part of the plurality of parts corresponds to one of the parties of the plurality of parties.

6. The system of claim 4 wherein the recording module is configured to segment the audio signal according to the different acoustic characteristics of the plurality of parties.

7. The system of claim 1 wherein the searching module is configured to, for each label of at least some of the one or more labels, search for putative instances of at least some of the one or more query phrases corresponding to the label in at least some of the plurality of segments which are associated with at least some of the plurality of parts.

8. The system of claim 1 wherein the searching module includes a speech processor and each putative instance is associated with a hit quality that characterizes a quality of recognition of a corresponding query phrase of the one or more query phrases.

9. The system of claim 1 wherein the searching module includes a wordspotting system.

10. The system of claim 1 wherein the searching module includes a text processor.

11. The system of claim 1 wherein at least some of the query phrases are known to be present in the first data.

12. The system of claim 1 wherein the first data is diarized according to the interaction.

13. A computer implemented method comprising:
receiving a first data representing an interaction among a plurality of parties, the first data identifying a plurality of parts of the interaction and identifying a plurality of segments associated with each part of the plurality of parts;
receiving a second data associating each of one or more labels with one or more corresponding query phrases;
searching the first data to identify putative instances of the query phrases; and
labeling the parts of the interaction associated with the identified putative instances of the query phrases with the labels corresponding to the identified query phrases.

14. The method of claim 13 wherein the first data represents an audio signal comprising the interaction among the plurality of speakers.

15. The method of claim 13 wherein the first data represents a text based chat log comprising the interaction among the plurality of speakers.

16. The method of claim 14 further comprising forming the first data representing the audio signal including recording an audio signal of the interaction between the plurality of parties, segmenting the audio signal into the plurality of segments, and associating each of the segments with a part of the plurality of parts, wherein each part of the plurality of parts corresponds to one of the parties of the plurality of parties.

17. The method of claim 15 further comprising forming the first data representing the text based chat log including logging a textual interaction between the plurality of parties, segmenting the textual interaction into the plurality of segments, and associating each of the segments with a part of the plurality of parts, wherein each part of the plurality of parts corresponds to one of the parties of the plurality of parties.

18. The method of claim 14 wherein segmenting the audio signal into the plurality of segments includes segmenting the audio signal according to the different acoustic characteristics of the plurality of parties.

19. The method of claim 13 wherein searching the first data includes, for each label of at least some of the one or more labels, searching for putative instances of at least some of the one or more query phrases corresponding to the label in at least some of the plurality of segments which are associated with at least some of the plurality of parts.

20. The method of claim 13 wherein searching the first data includes associating each putative instance with a hit quality that characterizes a quality of recognition of a corresponding query phrase of the one or more query phrases.

21. The method of claim 13 wherein at least some of the query phrases are known to be present in the first data.

22. The method of claim 13 wherein the first data is diarized according to the interaction.

23. Software stored on a computer-readable medium comprising instructions for causing a data processing system to:
receive a first data representing an interaction among a plurality of parties, the first data identifying a plurality of parts of the interaction and identifying a plurality of segments associated with each part of the plurality of parts;
receive a second data associating each of one or more labels with one or more corresponding query phrases;
search the first data to identify putative instances of the query phrases; and
label the parts of the interaction associated with the identified putative instances of the query phrases with the labels corresponding to the identified query phrases.
